(19) United States
(12) Patent Application Publication
(10) Pub. No.: US 2022/0207394 A1
(43) Pub. Date: Jun. 30, 2022

(54) GARMENT SIZE RECOMMENDATION SYSTEM

(71) Applicant: SelfieStyler, Inc., San Francisco, CA (US)

(72) Inventors: Craig Martens, San Francisco, CA (US); Alan Hess, San Francisco, CA (US); Shashwat Gupta, San Francisco, CA (US); Sean Montgomery, San Francisco, CA (US); Monika Horvat, San Francisco, CA (US); Jackson Kapinos, San Francisco, CA (US); Joe Moccia, San Francisco, CA (US); Justin Fondrie, San Francisco, CA (US)

(21) Appl. No.: 17/538,514

(22) Filed: Nov. 30, 2021

Related U.S. Application Data
(60) Provisional application No. 63/133,009, filed on Dec. 31, 2020.

(51) Int. Cl. G06N 5/04

(52) U.S. Cl. CPC G06N 5/04

(57) ABSTRACT

A method implemented by a computing system comprises receiving, by the computing system and from a user device, a subject profile information that specifies a plurality of body measurements associated with one or more images of a subject that are captured by the user device. The computing device receives a selection of a garment, where the garment is associated with a category, a brand, a style, and a plurality of sizes. A sizing recommendation engine of the computing system determines, based on the plurality of body measurements, a particular size of the garment that is associated with the subject profile information. The computing system communicates the particular size to the user device.

### CROSS REFERENCE TO RELATED APPLICATION

This application is a non-provisional application claiming priority to U.S. provisional application No. 63/133,009, filed Dec. 31, 2020, which is hereby incorporated by reference.

### BACKGROUND

### Field

This application generally relates to clothing. In particular, this application describes a garment size recommendation method and system for performing the method.

### Description of Related Art

Fashion brands do not have a standardized sizing system or a standard body shape used to manufacture clothing. Typically, brands use a single fit model as the base size and then grade up and down to create a pattern for each size. The goal is to manufacture sizes to fit the most common shapes and sizes of their consumers in the hope of selling the most garments. The problem this creates for consumers is uncertainty with the fit that may lead them to elect not to purchase the garment or purchase the garment in multiple sizes. This doesn't achieve either the manufacturer's goals as stated above or the subject's goal of buying a specific garment.

There are several reasons why a garment may not fit a customer. For example, the garment may run large or small, meaning that the size the customer is used to buying is incorrect. In some cases, the size run may not go high or low enough to fit the customer. In yet other cases, the cut of the garment does not match the body shape of the customer, so no sizes of the style will fit.

### SUMMARY

In a first aspect, a method implemented by a computing system comprises receiving, by the computing system and from a user device, a subject profile information that specifies a plurality of body measurements associated with one or more images of a subject that are captured by the user device. The computing device receives a selection of a garment, where the garment is associated with a category, a brand, a style, and a plurality of sizes. A sizing recommendation engine of the computing system determines, based on the plurality of body measurements, a particular size of the garment that is associated with the subject profile information. The computing system communicates the particular size to the user device.

In a second aspect, a computing system includes a memory and a processor. The memory stores instruction code. The processor is in communication with the memory. The instruction code is executable by the processor to cause the computing system to perform operations that include receiving, from a user device, a subject profile information that specifies a plurality of body measurements associated with one or more images of a subject that are captured by the user device. The computing device receives a selection of a garment, where the garment is associated with a category, a brand, a style, and a plurality of sizes. A sizing recommendation engine of the computing system determines, based on the plurality of body measurements, a particular size of the garment that is associated with the subject profile information. The computing system communicates the particular size to the user device.

In a third aspect, a non-transitory computer-readable medium having stored thereon instruction code is provided. When the instruction code is executed by one or more processors of a computing system, the computing system performs operations that include receiving, from a user device, a subject profile information that specifies a plurality of body measurements associated with one or more images of a subject that are captured by the user device. The computing device receives a selection of a garment, where the garment is associated with a category, a brand, a style, and a plurality of sizes. A sizing recommendation engine of the computing system determines, based on the plurality of body measurements, a particular size of the garment that is associated with the subject profile information. The computing system communicates the particular size to the user device.

### BRIEF DESCRIPTION OF THE DRAWINGS

The accompanying drawings are included to provide a further understanding of the claims, are incorporated in, and constitute a part of this specification. The detailed description and illustrated examples described serve to explain the principles defined by the claims.

FIG. 1 illustrates an environment that includes various systems/devices that facilitate recommendation of the size of a garment, in accordance with an example.

FIG. 2 illustrates a user device, in accordance with an example.

FIG. 3 illustrates operations performed by the user device that facilitate obtaining accurate human body measurements from a digital image, in accordance with an example.

FIG. 4 illustrates body measurements determined according to the operations above from one or more images, in accordance with an example.

FIG. 5 illustrates a garment size recommendation system (GSRS), in accordance with an example.

FIG. 6 illustrates calibrated member records stored in a database of the GSRS, in accordance with an example.

FIG. 7 illustrates garment records stored in the GSRS database, in accordance with an example.

FIG. 8 illustrates operations performed by the GSRS in training a recommendation engine of the GSRS to determine the appropriate size of a garment to recommend to a subject, in accordance with an example.

FIG. 9 illustrates operations performed by the GSRS when recommending the size of a garment, in accordance with an example.

FIG. 10 illustrates a method performed by one or more systems or devices described herein, in accordance with an example.

FIG. 11 illustrates a computer system that can form part of or implement any of the systems or devices of the environment, in accordance with an example.

### DETAILED DESCRIPTION

Various examples of systems, devices, and/or methods are described herein. Words such as “example” and “exemplary” that may be used herein are understood to mean “serving as an example, instance, or illustration.” Any embodiment, implementation, and/or feature described herein as being an “example” or “exemplary” is not necessarily to be construed as preferred or advantageous over any other embodiment, implementation, and/or feature unless stated as such. Thus, other embodiments, implementations, and/or features may be utilized, and other changes may be made without departing from the scope of the subject matter presented herein.

Accordingly, the examples described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Moreover, terms such as “substantially” or “about” that may be used herein are meant that the recited characteristic, parameter, or value need not be achieved exactly, but that deviations or variations, including, for example, tolerances, measurement error, measurement accuracy limitations and other factors known to those skilled in the art, may occur in amounts that do not preclude the effect the characteristic was intended to provide.

As noted above, there are several reasons why a garment may not fit a customer, such as the garment running too large or too small, the garment not going high or low enough to fit the customer, and/or the cut of the garment not matching the body shape of the customer. Some of these issues are ameliorated by examples of garment size recommendation systems (GSRSs) disclosed herein.

An example of a GSRS is configured to receive subject profile information that specifies a plurality of body measurements associated with one or more images of a subject that are captured by a user device. The GSRS is further configured to receive a selection of a garment. The garment is associated with a category, a brand, a style, and a plurality of sizes. Examples of categories include shirts, pants, skirts, blouses, etc. Examples of brands include Gap®, Ann Taylor®, Talbots®, etc. The styles may be specific to particular brands. For instance, Gap® women's jeans styles include jeggings, skinny, slim & straight, relaxed, etc. Each specific style of a specific brand is associated with different sizes, and these sizes may be specified differently depending on the brand and style (e.g., size 1, size 2, size 3, petite, large, slim, wide, etc.).

The GSRS is configured to determine, based on the plurality of body measurements, a particular size of the garment that is associated with the subject profile information; and communicate the particular size to the user device.

In an example, the GSRS includes a sizing recommendation engine. An example of the sizing recommendation engine includes machine learning (ML) logic that is trained with calibrated member training data to recommend garment sizes. Examples of the calibrated member training data specify profile information (e.g., body measurements) associated with a large number of consumers and garment selections (e.g., garments selected by the consumers indicated as being a good fit). In general, the profile information is obtained from digital images of various views of the consumers (e.g., front-view, side-view, etc.). Feedback provided by these consumers facilitates determining whether particular garments are a good fit.

In operation, after the GSRS recommends a particular size of garment to a subject, that subject can provide feedback regarding the garment fit. The subject's profile information, garment selection, and feedback regarding the fit can be added to the calibrated member training data to improve the accuracy of the size recommendations over time.

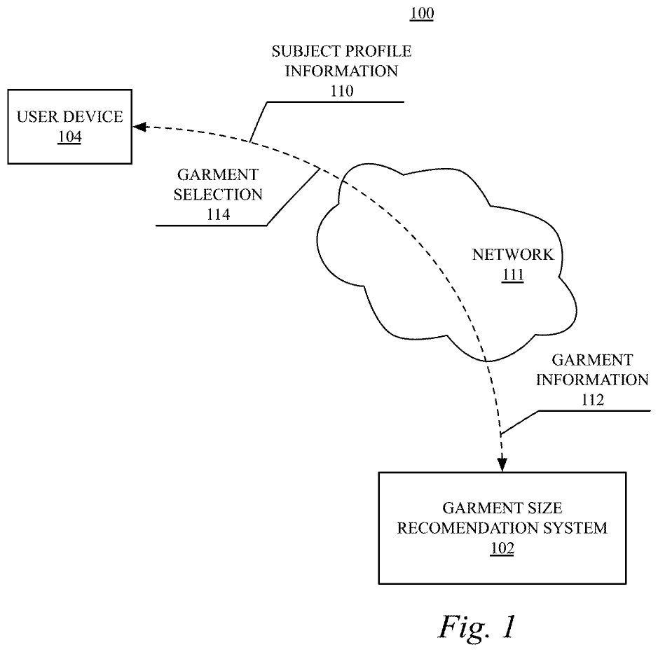

FIG. 1 illustrates an example of an environment 100 that includes various systems/devices that facilitate recommendation of the size of a garment. Example systems/devices of the environment 100 include a user device 104 and a garment size recommendation system (GSRS) 102. As described in more detail below, the user device 104 is configured to communicate subject profile information 110 (e.g., subject body measurements) and a garment selection 114 (e.g., a particular garment category, brand, and style) to the GSRS 102. In response to receiving this information, the GSRS 102 is configured to determine garment information 112 (e.g., size of garment associated with subject body measurements) and, in some examples, communicate the garment information 112 to the user device 104. In an example, the user device 104 and GSRS 102 communicate information to one another via a communication network 111, such as a cellular communication network, a WiFi network, etc.

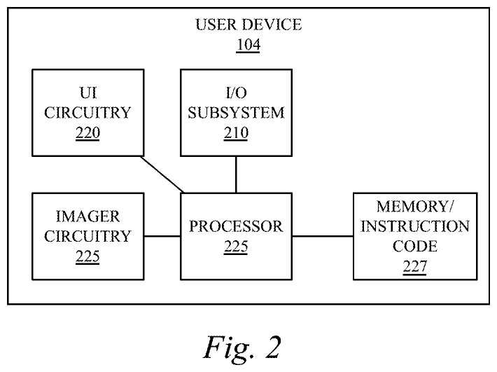

FIG. 2 illustrates an example of the user device 104. An example of the user device 104 corresponds to a home computer, tablet, etc. An example of the user device 104 corresponds to a wearable device, such as a mobile device (e.g., mobile phone, watch, etc.). An example of the user device 104 includes a memory 227 and a processor 205. Another example of the user device 104 also includes an input/output (I/O) subsystem 210, user interface (UI) circuitry 220, and imager circuitry 225.

An example of the processor 205 is in communication with the memory 227. The processor 205 is configured to execute instruction code stored in the memory 227. The instruction code facilitates performing, by the user device 104, various operations that are described below. In this regard, the instruction code can cause the processor 205 to control and coordinate various activities performed by the different subsystems of the user device 104. An example of the processor 205 corresponds to a stand-alone computer system such as an Intel®, AMD®, or PowerPC® based computer system or a different computer system and can include application-specific computer systems. An example of the computer system includes an operating system, such as Linux, Unix®, or a different operating system.

An example of the I/O subsystem 210 includes one or more input/output interfaces configured to facilitate communications with other systems of the user device 104 and/or entities outside of the user device 104. For instance, an example of the I/O subsystem 210 includes wired or wireless communication circuitry configured to facilitate communicating information to and from the GSRS 102. An example of the wireless communication circuitry includes cellular telephone communication circuitry configured to communicate information over a cellular telephone network such as a 3G, 4G, and/or 5G network. Other examples of the wireless communication circuitry facilitate communication of information via an 802.11 based network, Bluetooth®, Zigbee®, near field communication technology, or a different wireless network.

An example of the UI circuitry 220 includes display circuitry and audio circuitry. An example of the display circuitry includes a liquid crystal display (LCD), light-emitting diode (LED) display, etc. An example of the display circuitry includes a transparent capacitive touch layer that facilitates receiving user commands. An example of the audio circuitry includes one or more digital-to-analog converters (DAC), analog-to-digital converters (ADC), amplifiers, speakers, microphones, etc. An example of the display circuitry is configured to depict a graphical user interface (GUI). An example of the GUI is configured to generate an overlay over some or all of the content being rendered by the display. An example of the overlay facilitates displaying static text/images and/or video content.

An example of the imager circuitry 225 includes an image sensor such as a charge-coupled device (CCD), an active-pixel sensor, etc., for capturing pixels of information associated with an image. An example of the imager circuitry 225 includes distance measurement circuitry (e.g., laser distance circuitry) that facilitates determining a distance between a subject and the image sensor.

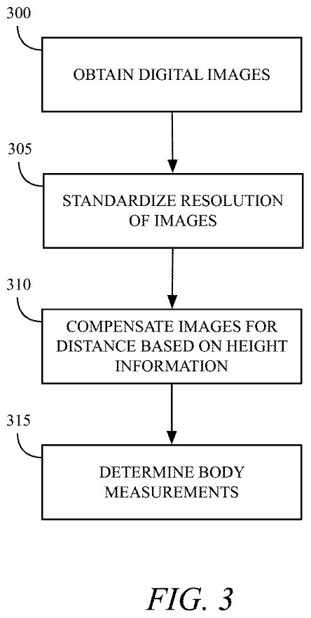

FIG. 3 illustrates examples of operations performed by the user device 104 that facilitate obtaining accurate human body measurements from a digital image. In this regard, one or more of the operations can be implemented via instruction code, stored in the memory of the user device 104 configured to cause the processor of the user device 104 to perform the operations illustrated in the figures and discussed herein.

At block 300, digital images are obtained. For instance, in an example, the user device 104 is configured to generate a user interface via the UI circuitry 220 that prompts a subject to perform a group of image capture operations that together facilitate determining subject profile information 110. For instance, in an example, the user device 104, via a group of visual and/or audio prompts, instructs the subject to arrange the user device 104 in a manner that facilitates capturing one or more images of the subject. The image is captured by the imager circuitry 225. An example of the image is a full-body image (e.g., a head to toe image). In an example, the image of the subject is presented live on the display. In an example, target regions are overlaid onto the image, and the subject is instructed to align particular body regions (e.g., head, hips, etc.) within particular target regions. In some examples, audio prompts communicated via the audio circuitry instruct the subject to move in particular directions to facilitate alignment of the image.

Examples of the images captured by the user device include front-facing images, side-facing images with the arms being up, and side-facing images with the arms being down. In some examples, two or more of these images are utilized in determining the subject profile information 110 (e.g., one front-facing and one side-facing image). In some cases, multiple images are required because the subject's arms can, in some instances, block other parts of the body needed to facilitate accurate measurements.

At block 305, the resolutions of the images capture above are standardized. For instance, in an example, the images are converted to a standard resolution (e.g., 960 by 1280). In some instances, the angle of the user device 104 during image capture is known (e.g., via a gyroscope of the user device 104). In some examples, if the angle is known, the images are further manipulated to compensate for the angle of the user device 104. (e.g., to compensate for any trapezoidal distortion in the image).

At block 310, the images are compensated for distance based on height information associated with the subject. In an example, the subject is prompted to provide height information. In another example, the subject's height is stored in user profile information associated with the subject. In an example, for each image, two horizontal markings (or other suitable indications) are placed or overlaid at the top and bottom of the image. The distance between these markings denotes the subject's height in that image. A pixel-per-inch metric for the subject's height is determined based on the number of pixels in the image between the two horizontal markings and the subject's height. In some embodiments, the pixel-per-inch metric depends on a standardized distance between the camera and the subject. The digital image is corrected (e.g., by adjusting the size and/or scale of the image) to a standardized size based at least in part on a specified number of pixels that the subject's image should be depending on the pixel-per-inch metric.

At block 315, body measurements are determined. In some examples, one or more locations in the images that need to be measured are marked or overlaid with a visual indicator. In some embodiments, the locations are specified by the subject. Examples of body measurements include linear measurement and circumferential measurements.

An example of a linear measurement corresponds to a linear length of a region of an image (e.g., inseam, height, arm span, sleeve length, etc.). Examples of the linear measurements use a simplified pixel-per-inch calculation that varies by the “marked” locations in the digital image to be measured.

An example of a circumferential measurement uses a distance measurement from the front-facing image and at least one side-facing image. Pixel measurements from these images can be applied to several different formulas that facilitate determining the perimeter of an ellipse based on pixels taken from two different images. In some embodiments, the pixels are converted to inches along with a modifier that varies by measurement location in the image and a standard distance from the user device 104 to the subject. Examples of circumference measurements include but are not limited to neck circumference, bust circumference, waist circumference, abdomen circumference, waist circumference, high hip circumference, low hip circumference, thigh circumference, calf circumference, ankle circumference, bicep circumference, etc. To obtain consistent results, a set of rules is used to place/overlay the horizontal lines (or other suitable indication) onto the images.

An example of a circumference measurement, p, is obtained according to any of the following equations:

$$p \approx 2 π \sqrt{\frac{{a}^{2} + {b}^{2}}{2}}$$

$$p \approx π [ 3 ( a + b ) - \sqrt{( 3 a + b ) ( a + 3 b )} ]$$

$$p \approx π ( a + b ) ( 1 + \frac{3 h}{10 + \sqrt{4 - 3 h}} )$$

$$p \approx π ( a + b ) {\sum }_{i = 0}^{∞} {( \begin{matrix}.5 \\ n\end{matrix} )}^{2} {h}^{2}$$

$$p \approx 2 a π ( 1 - {\sum }_{i - 1}^{∞} \frac{{( 2 i ) !}^{2}}{{( 2 i + i ! )}^{4}} \frac{{e}^{2 i}}{2 i - 1} )$$

$$where$$

$$h = \frac{{( a - b )}^{2}}{{( a + b )}^{2}}$$

$$e = \frac{\sqrt{{a}^{2} - {b}^{2}}}{a}$$

and where, a is a pixel location in the front-facing digital image, and b is a pixel location in one of the side-facing digital images.

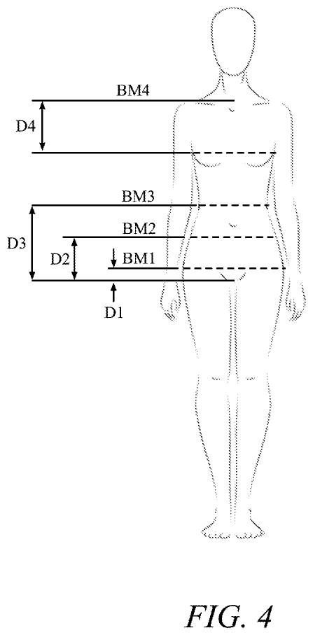

FIG. 4 illustrates examples of body measurements determined according to the operations above from one or more images. A first example body measurement, BM1, corresponds to a low hip measurement. A second example body measurement, BM2, corresponds to a high hip measurement. A third example body measurement, BM3, corresponds to a waist measurement. A fourth measurement, BM4, corresponds to a chest measurement.

The first, second, and third measurements together define a measurement profile associated with the waist region of the subject. As described in more detail below, this measurement profile facilitates determining, for example, the size (e.g., small, medium, large, etc.) of pants, skirts, etc. That is, these measurements facilitate determining the size of a garment for which measurements in these areas are key.

Each of these measurements corresponds to a circumferential measurement determined according to one or more of the equations described above. In some examples, each body measurement (e.g., BM1, BM2, BM3, BM4) is further associated with a distance measurement (e.g., D1-D4) that specifies a distance from an anchor point to a region at which the measurement is taken. For instance, in an example, the anchor point associated with waist region measurements corresponds to the crotch area. In an example, the anchor point associated with chest region measurements corresponds to the top of the shoulder.

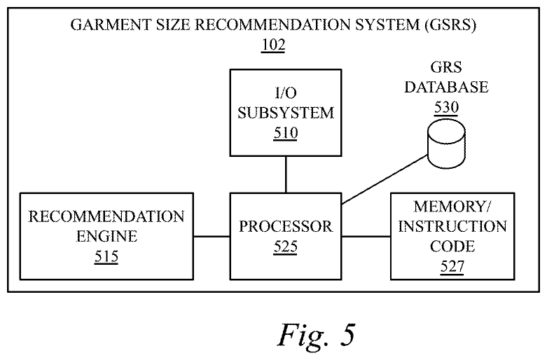

FIG. 5 illustrates an example of a garment size recommendation system (GSRS) 102. An example of the GSRS 102 includes a memory 527 and a processor 525. An example of GSRS 102 also includes an input/output (I/O) subsystem 510, a garment recommendation engine 515, and a GSRS database 530.

An example of the processor 525 is in communication with the memory 527. The processor 525 is configured to execute instruction code stored in the memory 527. The instruction code facilitates performing, by the GSRS 102, various operations that are described below. In this regard, the instruction code can cause the processor 525 to control and coordinate various activities performed by the different subsystems of the GSRS 102. The processor 525 can correspond to a stand-alone computer system such as an Intel®, AMD®, or PowerPC® based computer system or a different computer system and can include application-specific computer systems. The computer system can include an operating system, such as Linux, Unix®, or a different operating system.

An example of the I/O subsystem 510 includes one or more input/output interfaces configured to facilitate communications with entities outside of the GSRS 102. An example of the I/O subsystem 510 is configured to communicate information via a RESTful API or a Web Service API. An example of I/O subsystem 510 implements a web browser to facilitate generating one or more web-based interfaces through which users of the GSRS 102, the user device 104, and/or other systems interact with the GSRS 102.

An example of the I/O subsystem 510 includes wired or wireless communication circuitry configured to facilitate communicating information to and from the GSRS 102. An example of the wireless communication circuitry includes cellular telephone communication circuitry configured to communicate information over a cellular telephone network such as a 3G, 4G, and/or 5G network. Other examples of the wireless communication circuitry facilitate communication of information via an 802.11 based network, Bluetooth®, Zigbee®, near field communication technology, or a different wireless network.

An example of the garment recommendation engine 515 is configured to, alone or in combination with other subsystems of the GSRS 102, determine the size of a garment most likely to comfortably fit the subject associated with the subject profile information 110. As described in further detail below, an example of the garment recommendation engine 515 includes different machine learning models for different styles of garments, brands of garments, and categories of garments. The garment recommendation engine 515 is configured to select the machine learning model most likely to correctly predict/determine the size of garment that matches the subject profile information 110. The machine learning model selected in a particular situation depends on the availability of information used for training the model. Examples of the machine learning models are trained with information provided in the GSRS database 530.

Some examples of the garment recommendation engine 515 include hardware, software, or a combination thereof that is specifically configured to implement or assist in the implementation of various supervised and unsupervised machine learning models. Within examples, these can involve implementation of a Holt-Winters algorithm, exponential time smoothing (ETS) algorithm, an artificial neural network (ANN), a recurrent neural network (RNN), a seasonal autoregressive moving average (SARIMA) algorithm, a network of long short-term memories (LSTM), a gated recurring unit (GRU) algorithm. Examples of the garment recommendation engine 315 can implement other machine learning (ML) logic and/or AI algorithms.

Machine learning models implemented by the garment recommendation engine 515 are evaluated by K-Fold cross-validation with a 90/10 train-test split set across several different algorithms—Logistic Regression, Support Vector Classifier [‘Linear,’ ‘poly,’ ‘rbf,’ ‘sigmoid’], Random Forest Classifier, K-Neighbors Classifier, Gradient Boosting Classifier, Extreme Gradient Boosting Classifier, Multi-layer Perceptron classifier. The previous algorithms mentioned are all multiclass classification models—where the target variables are the different sizes available for a particular garment. All models undergo an automated process of feature importance using a Random Forest Classifier, and all models undergo hyperparametric tuning.

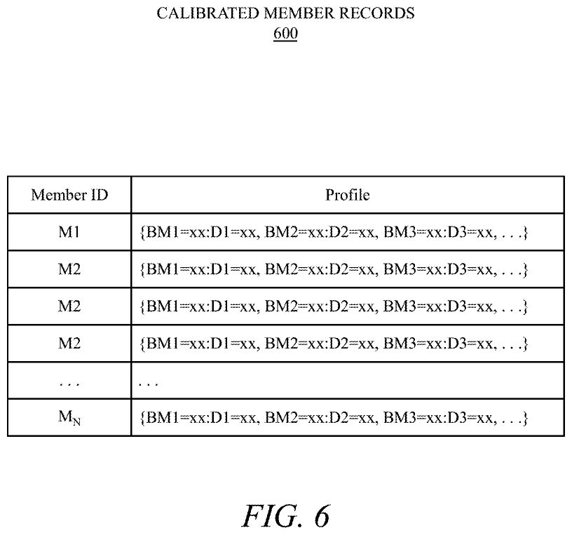

FIG. 6 illustrates an example of calibrated member records 600 stored in the GSRS database 530. In an example, the calibrated member records 600 include a member ID field and a profile field. An example of a member ID field specifies information (e.g., a randomly assigned value, a hash of calibrated member data) that uniquely identifies a particular member (e.g., a particular subject). An example of the profile field specifies profile information (e.g., body measurements BM1:D1, BM2:D2, BM3:D3, and BM4:D4, etc., illustrated FIG. 4) associated with a corresponding member. In some examples, the profile information is determined via a device such as the user device 104, described above.

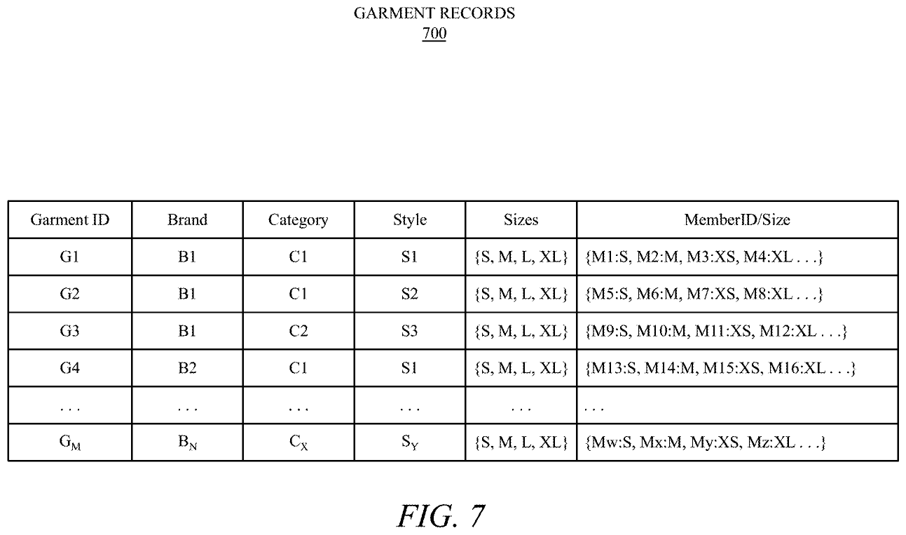

FIG. 7 illustrates an example of garment records 700 stored in the GSRS database 530. In an example, the garment records 700 include a garment ID field, a brand field, a category field, a style field, a sizes field, and a memberID/size field. An example of a garment ID field specifies information (e.g., a randomly assigned value, a hash of garment data) that uniquely identifies a particular garment (e.g., a particular item of clothing from a particular manufacture). An example of the brand, category, and style fields specifies the particular brand, category, and style associated with the garment. For example, the category for a pair of blue jeans may be “pants.” The brand of blue jeans may be Levi's©. The style of the blue jeans may be “loose fit.” The sizes field specifies the different sizes in which the garment is available. For instance, following the example above, the particular blue jeans may come in the sizes small, medium, and large. The sizes may be specified differently for different garments (e.g., petite, slim, wide, etc.).

The member ID/Size field specifies the member IDs of calibrated members who indicated that the corresponding garment was a good fit. The member ID/size field further specifies the size of the garment indicated by each member as being a good fit. For example, according to FIG. 7, member M1 selected a size S of garment G1. Member M2 selected a size M of garment G1.

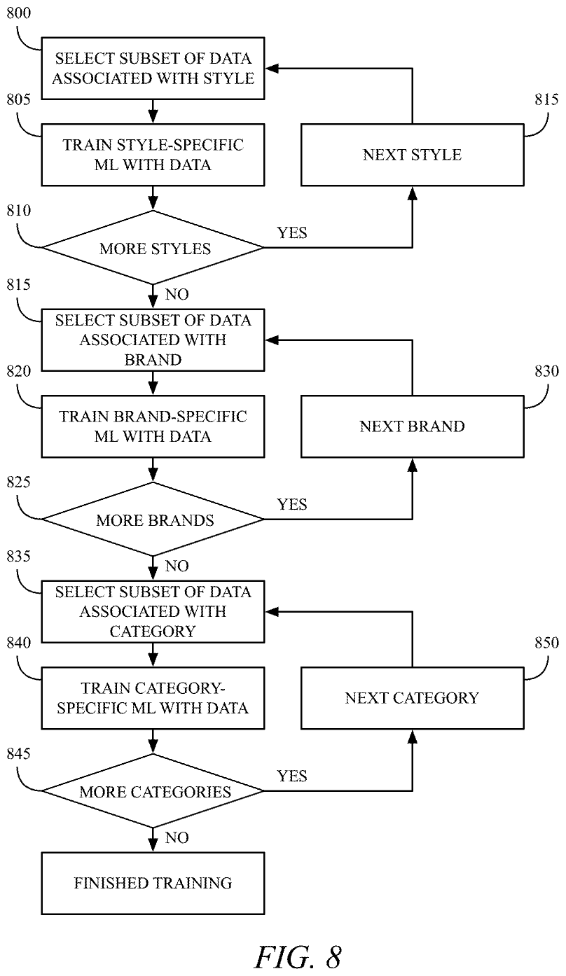

FIG. 8 illustrates examples of operations performed by GSRS 102 in training the garment recommendation engine 515 to determine the appropriate size of a garment to recommend to a subject. In this regard, one or more of the operations can be implemented via instruction code, stored in the memory of the GSRS 102 configured to cause the processor of the GSRS 102 to perform the operations illustrated in the figures and discussed herein.

At block 800, a subset of data associated with a particular style of garment is selected. For instance, in an example, all garment records 700 associated with the style Si are selected.

At block 805, a style-specific machine learning model is trained with the subset of data. An example of the machine learning (ML) model corresponds to a network of fully connected layers. The ML model includes an input layer node for each feature or body measurement that is relevant in predicting the size of the garment and an output layer node for each size in which the garment is available. For example, the most relevant body measurements for garments such as pants, skirts, etc., are body measurements BM1:D1, BM2:D2, and BM3:D3 described in FIG. 4, which all relate to waist measurements. The size of such a garment may be specified as small, medium, large, etc. In some examples, the relevance of one or more features/body measurements that facilitate sizing a garment is determined via an automated process that involves the use of a Random Forest Classifier configured to determine the importance of different features.

Training of the ML model involves iteratively setting the input layer nodes to relevant body measurements specified in profile information associated with each member ID specified in the memberID/size field and driving the output layer nodes (e.g., via backpropagation) to determine the size of the garment to correspond to the size of the garment selected by the member.

At block 810, if there are additional styles of garments, then at block 815, the next style of garment is selected, and the operations repeat from block 800.

At block 815, a subset of data associated with a particular brand of garment is selected. For instance, in an example, all garment records 700 associated with the brand B1 are selected.

At block 820, a brand-specific machine learning model is trained with the subset of data. Training of the brand-specific machine learning model proceeds in a manner similar to that of the style-specific machine learning model.

At block 825, if there are additional brands of garments, then at block 830, the next brand of garment is selected, and the operations repeat from block 815.

At block 835, a subset of data associated with a particular category of garment is selected. For instance, in an example, all garment records 700 associated with the category C1 are selected.

At block 840, a category-specific machine learning model is trained with the subset of data. Training of the brand-specific machine learning model proceeds in a manner similar to that of the style-specific machine learning model.

At block 845, if there are additional brands of garments, then at block 850, the next brand of garment is selected, and the operations repeat from block 835.

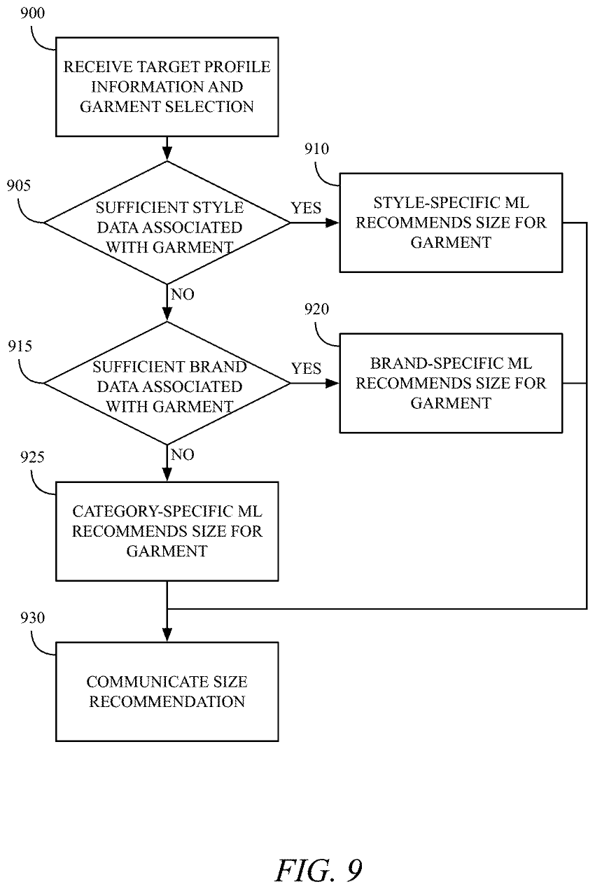

FIG. 9 illustrates examples of operations performed by GSRS 102 when recommending the size of a garment. In this regard, one or more of the operations can be implemented via instruction code, stored in the memory of the GSRS 102 configured to cause the processor of the GSRS 102 to perform the operations illustrated in the figures and discussed herein.

At block 900, subject profile information 110 and a garment selection 114 are received. For example, the GSRS 102 receives the subject profile information 110 and the garment selection 114 from the user device 104. An example of the subject profile information 110 specifies subject body measurements such as body measurements BM1:D1, BM2:D2, BM3:D3, and BM4:D4, illustrated in FIG. 4. Examples of the body measurements correspond to linear measurement and circumferential measurements of various regions of the subject. Examples of the body measurements specify distances from various anchor points of the subject to the region (e.g., from the crotch area, from the top of the shoulders).

An example of the garment selection specifies a particular garment. The garment is associated with a particular category, a particular brand, and a particular style of that brand.

At block 905, if there is sufficient style-related data associated with the style of the selected garment, then at block 910, a style-specific ML model recommends the size for the selected garment. In an example, the sufficiency of data is based on whether enough style-related data was available to train the style-specific ML model. In an example, the amount of data is determined to be sufficient when the subset of calibrated member training data used to train the style-specific ML model includes a threshold amount of calibrated member training data for each of a plurality of sizes associated with the style of garment. For instance, in an example where the style of the selected garment comes in small, medium, and large, the amount of training data is deemed sufficient when a threshold number of calibrated members (e.g., twenty members) selected each of the different sizes (e.g., at least twenty members selected the small version of the style, at least twenty members selected the medium version of the style, and at least twenty members selected the larger version of the style).

If the amount of data is sufficient, then the body measurements of the profile information that are relevant to the selected garment are input to the style-specific ML, and the style-specific ML outputs a recommended size for that style of garment. At block 930, the recommended size is communicated to the user device 104.

If at block 905, there is insufficient style-related data associated with the style of the selected garment, then if at block 915, there is sufficient brand-related data associated with the brand of the selected garment, then at block 920, a brand-specific ML model recommends the size for the garment. In an example, the sufficiency of data is based on whether enough brand-related data was available to train the brand-specific ML model. In an example, the amount of data is determined to be sufficient when the subset of calibrated member training data used to train the brand-specific ML model includes a threshold amount of calibrated member training data for each of a plurality of sizes associated with the brand of the selected garment. For instance, in an example where the selected garment comes in small, medium, and large, the amount of training data is deemed sufficient when a threshold number of calibrated members (e.g., twenty members) selected, within that brand of garment, each of the different sizes (e.g., at least twenty members selected a garment of the brand in a small version, at least twenty members selected a garment of the brand in the medium version, and at least twenty members selected a garment of the brand in the large version of the brand). Note that the particular garment selected by the calibrated members need not be the same as the garment selected by the subject. Rather, the brand of the garment selected by the calibrated members is the same as the brand of the garment selected by the subject.

If the amount of data is sufficient, then the body measurements of the profile information that are relevant to the selected garment are input to the brand-specific ML, and the brand-specific ML outputs a recommended size for that style of garment. At block 930, the recommended size is communicated to the user device 104.

If at block 915, there is insufficient brand-related data associated with the brand of the selected garment, then at block 925, a category-specific ML model recommends the size for the garment. And at block 930, the recommended size is communicated to the user device 104.

It will be appreciated that the operations described above can be performed differently. For instance, in another example, the GSRS 102 may be configured to refrain from training a particular style ML model, a particular brand ML model, and/or a particular category ML model until a threshold amount of data is available to train the corresponding model. For instance, in an example where the style of a particular garment comes in small, medium, and large, the amount of training data is deemed sufficient when a threshold number of calibrated members (e.g., twenty members) selected each of the different sizes (e.g., at least twenty members selected the small version of the style, at least twenty members selected the medium version of the style, and at least twenty members selected the larger version of the style). In an example, similar logic is applied to determining whether there is sufficient data to train a particular brand ML model and/or a particular category ML model. I.e., that there are a sufficient number of instances where calibrated members selected all the sizes (e.g., twenty calibrated members selected each size) associated with garments of a particular brand or garments of a particular category.

In this example, when making a recommendation, the GSRS 102 determines first whether an ML model exists for a particular style, brand, or category. The existence of the model implies that there is sufficient data for the corresponding model. In this case, the GSRS 102 selects the best available model to make the recommendation. For instance, in an example, the GSRS 102, select the style ML model, if available, otherwise, the brand ML model, if available, otherwise, the category ML model, if available to make the recommendation.

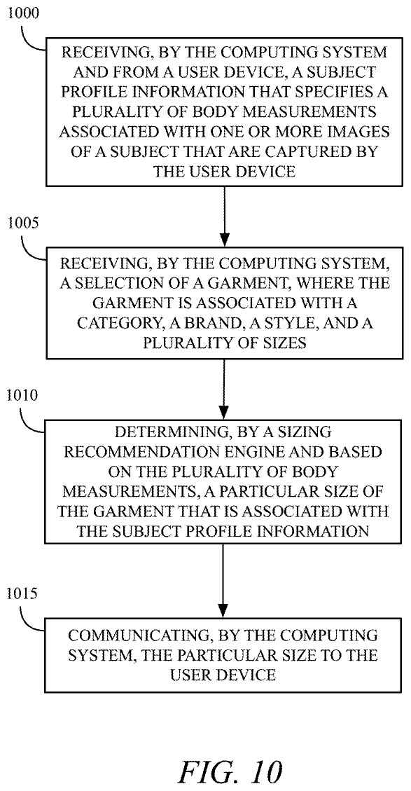

FIG. 10 illustrates an example of a method that can be performed by one or more systems or devices described herein.

Block 1000 involves receiving, by the computing system and from a user device, a subject profile information that specifies a plurality of body measurements associated with one or more images of a subject that are captured by the user device.

Block 1005 involves receiving, by the computing system, a selection of a garment, where the garment is associated with a category, a brand, a style, and a plurality of sizes.

Block 1010 involves determining, by a sizing recommendation engine of the computing system and based on the plurality of body measurements, a particular size of the garment that is associated with the subject profile information.

Block 1015 involves communicating, by the computing system, the particular size to the user device.

An example of the method involves training the sizing recommendation engine with calibrated member training data that specifies a plurality of profiles associated with different subjects, and for each subject, garment information that specifies one or more garments selected by the subject, wherein for each garment, the garment information specifies a category, a brand, a style, and a size.

An example of the method involves receiving, from the user device, an indication of whether the particular size of garment communicated to the user device fits the subject. This example further involves updating the calibrated member training data to include the subject profile information, the selected garment, and the particular size of garment when the particular size of garment fits the subject.

In an example of the method, the sizing recommendation engine includes style-specific recommendation logic for each of a plurality of different styles, brand-specific recommendation logic for each of a plurality of different brands, and category-specific recommendation logic for each of a plurality of different categories. This example involves training the style-specific recommendation logic with a subset of calibrated member training data associated with a corresponding style to determine a particular size of a selected garment of that style associated with the subject profile information; training brand-specific recommendation logic with a subset of calibrated member training data associated with a corresponding brand to determine a particular size of a selected garment of that brand associated with the subject profile information; and training category-specific recommendation logic with a subset of calibrated member training data associated with a corresponding category to determine a particular size of a selected garment of that category associated with the subject profile information.

In an example of the method, determining the particular size of the garment that is associated with the subject profile information further involves, responsive to determining that the subset of calibrated member training data associated with a style of the selected garment includes a threshold amount off calibrated member training data for each of the plurality of sizes associated with the garment, determining, by the style-specific recommendation logic and based on the plurality of body measurements, a particular size of the garment that is associated with the subject profile information; otherwise, responsive to determining that the subset of calibrated member training data associated with a brand of the selected garment includes a threshold amount off calibrated member training data for each of a plurality of sizes associated with the brand, determining, by the brand-specific recommendation logic and based on the plurality of body measurements, a particular size of the garment that is associated with the subject profile information; and otherwise, determining, by the category-specific recommendation logic and based on the plurality of body measurements, a particular size of the garment that is associated with the subject profile information.

In an example of the method, each body measurement specifies a circumferential distance around a region of the subject and a distance between a particular anchor point of the subject and the region.

In an example of the method, the one or more images of the subject include a front view of the subject and a side-view of the subject.

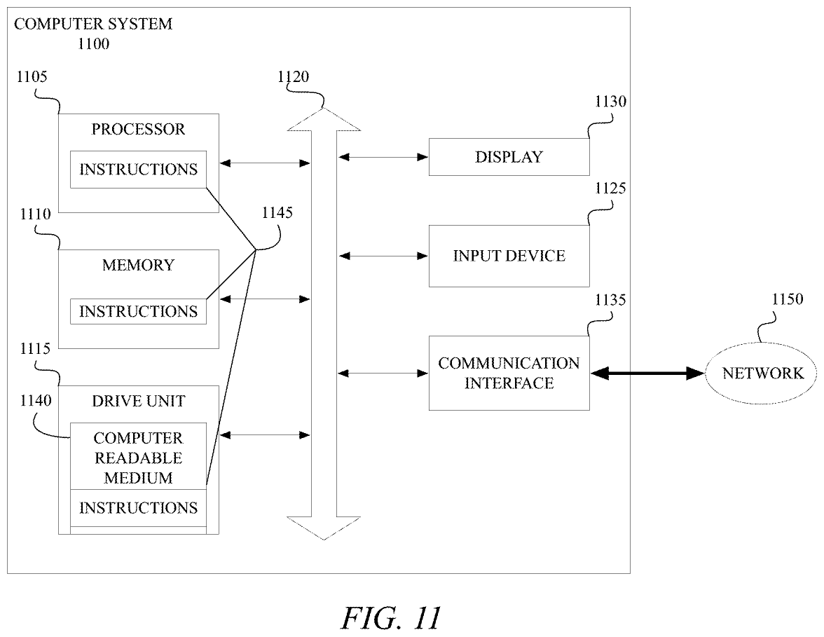

FIG. 11 illustrates an example of a computer system 1100 that can form part of or implement any of the systems and/or devices described above. The computer system 1100 can include a set of instructions 1145 that the processor 1105 can execute to cause the computer system 1100 to perform any of the operations described above. An example of the computer system 1100 can operate as a stand-alone device or can be connected, e.g., using a network, to other computer systems or peripheral devices.

In a networked example, the computer system 1100 can operate in the capacity of a server or as a client computer in a server-client network environment, or as a peer computer system in a peer-to-peer (or distributed) environment. The computer system 1100 can also be implemented as or incorporated into various devices, such as a personal computer or a mobile device, capable of executing instructions 1145 (sequential or otherwise), causing a device to perform one or more actions. Further, each of the systems described can include a collection of subsystems that individually or jointly execute a set, or multiple sets, of instructions to perform one or more computer operations.

The computer system 1100 can include one or more memory devices 1110 communicatively coupled to a bus 1120 for communicating information. In addition, code operable to cause the computer system to perform operations described above can be stored in the memory 1110. The memory 1110 can be random-access memory, read-only memory, programmable memory, hard disk drive, or any other type of memory or storage device.

The computer system 1100 can include a display 1130, such as a liquid crystal display (LCD), a cathode ray tube (CRT), or any other display suitable for conveying information. The display 1130 can act as an interface for the user to see processing results produced by processor 1105.

Additionally, the computer system 1100 can include an input device 1125, such as a keyboard or mouse or touchscreen, configured to allow a user to interact with components of system 1100.

The computer system 1100 can also include a disk or optical drive unit 1115. The drive unit 1115 can include a computer-readable medium 1140 in which the instructions 1145 can be stored. The instructions 1145 can reside completely, or at least partially, within the memory 1110 and/or within the processor 1105 during execution by the computer system 1100. The memory 1110 and the processor 1105 also can include computer-readable media as discussed above.

The computer system 1100 can include a communication interface 1135 to support communications via a network 1150. The network 1150 can include wired networks, wireless networks, or combinations thereof. The communication interface 1135 can enable communications via any number of wireless broadband communication standards, such as the Institute of Electrical and Electronics Engineering (IEEE) standards 802.11, 802.12, 802.16 (WiMAX), 802.20, cellular telephone standards, or other communication standards.

Accordingly, methods and systems described herein can be realized in hardware, software, or a combination of hardware and software. The methods and systems can be realized in a centralized fashion in at least one computer system or in a distributed fashion where different elements are spread across interconnected computer systems. Any kind of computer system or other apparatus adapted for carrying out the methods described herein can be employed.

The methods and systems described herein can also be embedded in a computer program product, which includes all the features enabling the implementation of the operations described herein and which, when loaded in a computer system, can carry out these operations. Computer program as used herein refers to an expression, in a machine-executable language, code or notation, of a set of machine-executable instructions intended to cause a device to perform a particular function, either directly or after one or more of a) conversion of a first language, code, or notation to another language, code, or notation; and b) reproduction of a first language, code, or notation.

While the systems and methods of operation have been described with reference to certain examples, it will be understood by those skilled in the art that various changes can be made and equivalents can be substituted without departing from the scope of the claims. Therefore, it is intended that the present methods and systems not be limited to the particular examples disclosed, but that the disclosed methods and systems include all embodiments falling within the scope of the appended claims.

1. A method implemented by a computing system, the method comprising:
receiving, by the computing system and from a user device, subject profile information that specifies a plurality of body measurements associated with one or more images of a subject that are captured by the user device;
receiving, by the computing system, a selection of a garment, where the garment is associated with a category, a brand, a style, and a plurality of sizes;
determining, by a sizing recommendation engine of the computing system and based on the plurality of body measurements, a particular size of the garment that is associated with the subject profile information; and
communicating, by the computing system, the particular size to the user device.

2. The method according to claim 1, further comprising:
training the sizing recommendation engine with calibrated member training data that specifies a plurality of profiles associated with different subjects, and for each subject, garment information that specifies one or more garments selected by the subject, wherein for each garment, the garment information specifies a category, a brand, a style, and a size.

3. The method according to claim 2, further comprising:
receiving, from the user device, an indication of whether the particular size of garment communicated to the user device fits the subject; and
when the particular size of garment fits the subject, updating the calibrated member training data to include the subject profile information, the selected garment, and the particular size of garment.

4. The method according to claim 2, wherein the sizing recommendation engine includes style-specific recommendation logic for each of a plurality of different styles, brand-specific recommendation logic for each of a plurality of different brands, and category-specific recommendation logic for each of a plurality of different categories, wherein the method comprises:
training the style-specific recommendation logic with a subset of calibrated member training data associated with a corresponding style to determine a particular size of a selected garment of that style associated with the subject profile information;
training brand-specific recommendation logic with a subset of calibrated member training data associated with a corresponding brand to determine a particular size of a selected garment of that brand associated with the subject profile information; and
training category-specific recommendation logic with a subset of calibrated member training data associated with a corresponding category to determine a particular size of a selected garment of that category associated with the subject profile information.

5. The method according to claim 4, wherein determining the particular size of the garment that is associated with the subject profile information further comprises:
responsive to determining that the subset of calibrated member training data associated with a style of the selected garment includes a threshold amount off calibrated member training data for each of the plurality of sizes associated with the garment, determining, by the style-specific recommendation logic and based on the plurality of body measurements, a particular size of the garment that is associated with the subject profile information;
otherwise, responsive to determining that the subset of calibrated member training data associated with a brand of the selected garment includes a threshold amount off calibrated member training data for each of a plurality of sizes associated with the brand, determining, by the brand-specific recommendation logic and based on the plurality of body measurements, a particular size of the garment that is associated with the subject profile information; and
otherwise, determining, by the category-specific recommendation logic and based on the plurality of body measurements, a particular size of the garment that is associated with the subject profile information.

6. The method according to claim 1, wherein each body measurement specifies a circumferential distance around a region of the subject and a distance between a particular anchor point of the subject and the region.

7. The method according to claim 1, wherein the one or more images of the subject include a front view of the subject and a side-view of the subject.

8. A computing system:
one or more processors; and
a memory in communication with the one or more processors, wherein the memory stores instruction code that, when executed by the one or more processors, causes the computing system to perform operations comprising:
receiving from a user device, subject profile information that specifies a plurality of body measurements associated with one or more images of a subject that are captured by the user device;
receiving a selection of a garment, where the garment is associated with a category, a brand, a style, and a plurality of sizes;
determining, by a sizing recommendation engine of the computing system and based on the plurality of body measurements, a particular size of the garment that is associated with the subject profile information; and
communicating the particular size to the user device.

9. The computing system according to claim 8, wherein the instruction code is executable to cause the computing system to perform operations comprising:
training the sizing recommendation engine with calibrated member training data that specifies a plurality of profiles associated with different subjects, and for each subject, garment information that specifies one or more garments selected by the subject, wherein for each garment, the garment information specifies a category, a brand, a style, and a size.

10. The computing system according to claim 9, wherein the instruction code is executable to cause the computing system to perform operations comprising:
receiving, from the user device, an indication of whether the particular size of garment communicated to the user device fits the subject; and
when the particular size of garment fits the subject, updating the calibrated member training data to include the subject profile information, the selected garment, and the particular size of garment.

11. The computing system according to claim 9, wherein the sizing recommendation engine includes style-specific recommendation logic for each of a plurality of different styles, brand-specific recommendation logic for each of a plurality of different brands, and category-specific recommendation logic for each of a plurality of different categories, wherein the instruction code is executable to cause the computing system to perform operations comprising:
training the style-specific recommendation logic with a subset of calibrated member training data associated with a corresponding style to determine a particular size of a selected garment of that style associated with the subject profile information;
training brand-specific recommendation logic with a subset of calibrated member training data associated with a corresponding brand to determine a particular size of a selected garment of that brand associated with the subject profile information; and
training category-specific recommendation logic with a subset of calibrated member training data associated with a corresponding category to determine a particular size of a selected garment of that category associated with the subject profile information.

12. The computing system according to claim 11, wherein in determining the particular size of the garment that is associated with the subject profile information, the instruction code is executable to cause the computing system to perform operations comprising:
responsive to determining that the subset of calibrated member training data associated with a style of the selected garment includes a threshold amount off calibrated member training data for each of the plurality of sizes associated with the garment, determining, by the style-specific recommendation logic and based on the plurality of body measurements, a particular size of the garment that is associated with the subject profile information;
otherwise, responsive to determining that the subset of calibrated member training data associated with a brand of the selected garment includes a threshold amount off calibrated member training data for each of a plurality of sizes associated with the brand, determining, by the brand-specific recommendation logic and based on the plurality of body measurements, a particular size of the garment that is associated with the subject profile information; and
otherwise, determining, by the category-specific recommendation logic and based on the plurality of body measurements, a particular size of the garment that is associated with the subject profile information.

13. The computing system according to claim 8, wherein each body measurement specifies a circumferential distance around a region of the subject and a distance between a particular anchor point of the subject and the region.

14. The computing system according to claim 8, wherein the one or more images of the subject include a front view of the subject and a side-view of the subject.

15. A non-transitory computer-readable medium having stored thereon instruction code that, when executed by one or more processors of a computing system, causes the computing system to perform operations comprising:
receiving from a user device, subject profile information that specifies a plurality of body measurements associated with one or more images of a subject that are captured by the user device;
receiving a selection of a garment, where the garment is associated with a category, a brand, a style, and a plurality of sizes;
determining, by a sizing recommendation engine of the computing system and based on the plurality of body measurements, a particular size of the garment that is associated with the subject profile information; and
communicating the particular size to the user device.

16. The non-transitory computer-readable medium according to claim 15, wherein the instruction code is executable to cause the computing system to perform operations comprising:
training the sizing recommendation engine with calibrated member training data that specifies a plurality of profiles associated with different subjects, and for each subject, garment information that specifies one or more garments selected by the subject, wherein for each garment, the garment information specifies a category, a brand, a style, and a size.

17. The computing system according to claim 16, wherein the instruction code is executable to cause the computing system to perform operations comprising:
receiving, from the user device, an indication of whether the particular size of garment communicated to the user device fits the subject; and
when the particular size of garment fits the subject, updating the calibrated member training data to include the subject profile information, the selected garment, and the particular size of garment.

18. The non-transitory computer-readable medium according to claim 16, wherein the sizing recommendation engine includes style-specific recommendation logic for each of a plurality of different styles, brand-specific recommendation logic for each of a plurality of different brands, and category-specific recommendation logic for each of a plurality of different categories, wherein the instruction code is executable to cause the computing system to perform operations comprising:
training the style-specific recommendation logic with a subset of calibrated member training data associated with a corresponding style to determine a particular size of a selected garment of that style associated with the subject profile information;
training brand-specific recommendation logic with a subset of calibrated member training data associated with a corresponding brand to determine a particular size of a selected garment of that brand associated with the subject profile information; and
training category-specific recommendation logic with a subset of calibrated member training data associated with a corresponding category to determine a particular size of a selected garment of that category associated with the subject profile information.

19. The non-transitory computer-readable medium according to claim 18, wherein in determining the particular size of the garment that is associated with the subject profile information, the instruction code is executable to cause the computing system to perform operations comprising:
responsive to determining that the subset of calibrated member training data associated with a style of the selected garment includes a threshold amount off calibrated member training data for each of the plurality of sizes associated with the garment, determining, by the style-specific recommendation logic and based on the plurality of body measurements, a particular size of the garment that is associated with the subject profile information;
otherwise, responsive to determining that the subset of calibrated member training data associated with a brand of the selected garment includes a threshold amount off calibrated member training data for each of a plurality of sizes associated with the brand, determining, by the brand-specific recommendation logic and based on the plurality of body measurements, a particular size of the garment that is associated with the subject profile information; and
otherwise, determining, by the category-specific recommendation logic and based on the plurality of body measurements, a particular size of the garment that is associated with the subject profile information.

20. The non-transitory computer-readable medium according to claim 15, wherein each body measurement specifies a circumferential distance around a region of the subject and a distance between a particular anchor point of the subject and the region.
